(19) United States
(12) Patent Application Publication
(10) Pub. No.: US 2016/0256892 A1
(43) Pub. Date: Sep. 8, 2016

(54) FILM COATING DEVICE AND FILM COATING METHOD USING SAME

(71) Applicant: SHENZHEN CHINA STAR OPTOELECTRONICS TECHNOLOGY CO., LTD, Shenzhen, Guangdong (CN)

(72) Inventor: Quan CHENG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/647,098

(22) PCT Filed: Jan. 19, 2014
(86) PCT No.: PCT/CN2014/070859

§ 371 Date: May 25, 2015

(30) Foreign Application Priority Data
Sep. 5, 2013 (CN) 201310400271.1

(51) Int. Cl. B05D 3/00; G02F 1/1337

(52) U.S. Cl. CPC B05D 3/007; G02F 1/1337

(57) ABSTRACT

The present invention discloses a film coating device that includes an ink sprayer, a holder, and a heater. The holder is used to hold a substrate to be coated a film. The ink sprayer sprays film material on the substrate with a preset spraying quantity and stepping rate. The heater heats the film material to a predetermined temperature range during the film spraying process in order to decrease a surface tension difference of the film material. The present invention also discloses a film coating method using the film coating device.

### FIELD OF THE INVENTION

The invention relates to film coating technologies, and particularly, to a film coating device and a film coating method using same.

### BACKGROUND OF THE INVENTION

In a current display panel manufacture, an alignment liquid is dropped on a glass substrate by ink jet technology. The alignment liquid is spread to become an alignment film via its own surface tension. However, the alignment liquid is uneven spread due to difference of surface tension of the alignment liquid, which leads to a bad uniformity of thickness of the alignment film and makes a terrible influence to an optical quality of the display panel.

Therefore, a film coating device and a film coating method using same which can solve the above-mentioned problem needs to be provided.

### SUMMARY OF THE INVENTION

To solve the above-mentioned problem, the present invention provides a film coating device that includes an ink sprayer, a holder, and a heater. The holder is used to hold a substrate to be coated a film. The ink sprayer sprays film material on the substrate with a preset spraying quantity and stepping rate. The heater heats the film material to a predetermined temperature range during the film spraying process in order to decrease a surface tension difference of the film material.

Wherein, the heater is set inside the holder to transfer the heat to the film material by heating the substrate.

Wherein, the ink sprayer comprises a receiving cavity and a plurality of nozzles spraying the film material on the substrate.

Wherein, the heater is set on the receiving cavity to directly heat the film material.

Wherein, the receiving cavity is extended along a first direction and moved along a second direction perpendicular to the first direction, and the nozzles are arranged along an extending direction of the receiving cavity and spaced with a predetermined interval.

Wherein, the receiving cavity is extended along a first direction, the ink sprayer is held still, and the holder is moved along the second direction.

Wherein, the film material is an alignment film of liquid crystal molecules.

A film coating method comprising steps of: providing a substrate; dropping a plurality of film material droplets on the substrate; heating the film material droplets on the substrate to a predetermined temperature; and spreading the film material droplets to form a film on the substrate.

Wherein, washing the substrate to decrease impurity particles on a surface of the substrate before dropping the film material droplets on the substrate.

Wherein, the predetermined temperature is set in a range of greater or equal to 10 Celsius degree and less than or equal to 60 Celsius degree.

Wherein, the film material is an alignment film of liquid crystal molecules.

The film coating device and the film coating method using same decrease the surface tension of the film material by heating the film material to a predetermined temperature. Thus, the film can be made more evenly.

### BRIEF DESCRIPTION OF THE DRAWINGS

In order to illustrate technical schemes of the present invention or the prior art more clearly, the following section briefly introduces drawings used to describe the embodiments and prior art. Obviously, the drawing in the following descriptions just is some embodiments of the present invention. The ordinary person in the related art can acquire the other drawings according to these drawings without offering creative effort.

FIG. 1 is a schematic structural view of a film coating device in accordance with an embodiment of the present invention; and

FIG. 2 is a flow chart of steps of a film coating method in accordance with an embodiment of the present invention.

### DETAILED DESCRIPTION OF THE PREFERRED EMBODIMENTS

The following sections offer a clear, complete description of the present invention in combination with the embodiments and accompanying drawings. Obviously, the embodiments described herein are only a part of, but not all of the embodiments of the present invention. In view of the embodiments described herein, any other embodiment obtained by the person skilled in the field without offering creative effort is included in a scope claimed by the present invention.

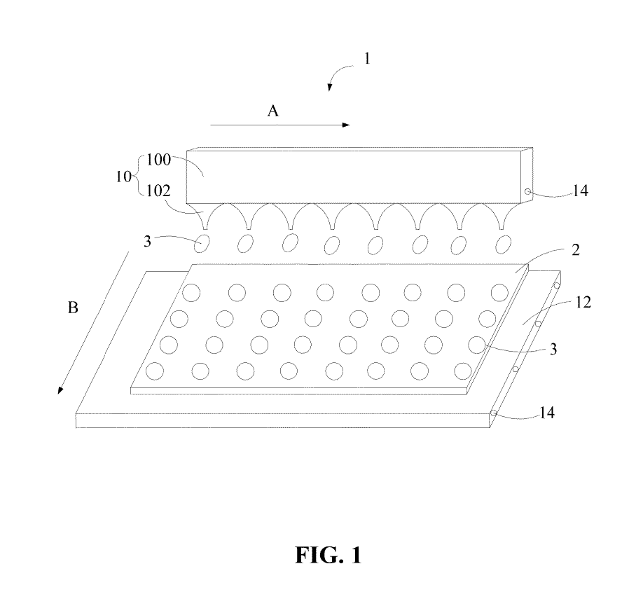

Referring to FIG. 1, a film coating device in accordance with an embodiment of the present invention includes an ink sprayer 10, a holder 12, and a heater 14. The holder 12 is used to hold a substrate 2 to be coated a film. The ink sprayer 10 sprays film material 3 on the substrate 2 with a preset spraying quantity and stepping rate. The heater 14 heats the film material 3 to a predetermined temperature range during the film spraying process in order to decrease a surface tension difference of the film material 3. In this embodiment, the film material 3 is an alignment film of liquid crystal molecules. The substrate 2 is a transparent glass substrate.

The ink sprayer 10 includes a receiving cavity 100 and a number of nozzles 102. The receiving cavity 100 is used to receive the film material 3. The receiving cavity 100 is extended along a first direction A and moved along a second direction B perpendicular to the first direction A. The nozzles 102 are arranged along an extending direction of the receiving cavity 100 and spaced with a predetermined interval. The film material 3 is formed to a droplet via the nozzle 102 and dropped on the substrate 2.

The holder 12 is a flat board broader than the substrate 2. The holder 12 is moved along the second direction B. Thus, the ink sprayer 10 can be held still and the holder 12 is moved along the second direction B to form a droplet matrix of the film material on the substrate 2.

The heater 14 can be a contact heating resistive heater, a non-contact electromagnetic heater, an ultrasonic heater, and an infrared heater. In this embodiment, the heater is set inside the holder 12 to transfer the heat to the film material 3 by heating the substrate 2. The holder 12 further includes a temperature detector (not shown) to real time monitor the temperature of the film material 3.

It is understood that, in the other embodiment, the heater 14 is also set on the receiving cavity 100 or the nozzles 102 to directly heat the film material 3.

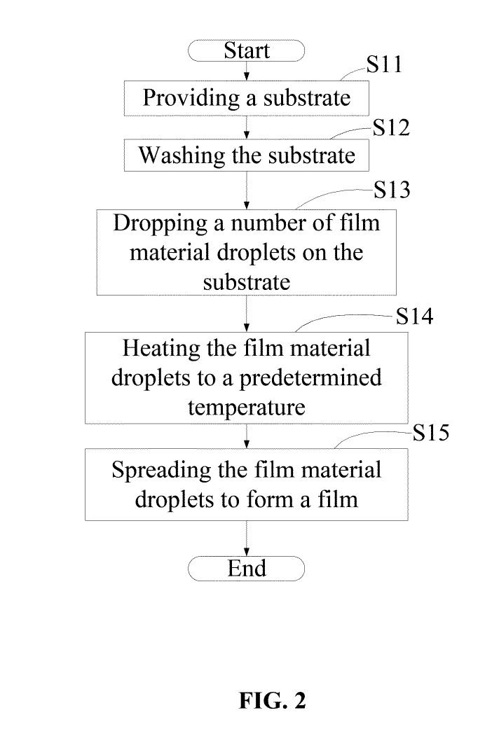

Referring to FIG. 2, a film coating method in accordance with an embodiment of the present invention includes following steps:

Step S11, a substrate 2 is provided. The substrate 2 may be a color filter substrate or a thin film transistor substrate.

Step S12, the substrate 2 is washed to decrease impurity particles on a surface of the substrate 2 in order to reduce the influence to a distribution of surface tension of the film material 3 made by the impurity particles.

Step S13, a number of film droplets are formed on the substrate 2. In this embodiment, the film material 3 is formed to the droplets via the nozzles 102 and dropped on the substrate 2 with a matrix form.

Step S14, the film material 3 droplets are heated to a predetermined temperature. According to an empirical Harkins formula about the liquid surface tension: F=M−0.145 t−0.00024 t², wherein F represents a surface tension of the film material 3, M represents an intermolecular force, and t represent the Celsius temperature. Thus, the surface tension of the film material 3 is dependent on the temperature and decrease with an increase of the temperature, which makes the film material 3 spreads more evenly. In this embodiment, the temperature of the film material is controlled in a range of greater or equal to 10 Celsius degree and less than or equal to 60 Celsius degree.

Step S15, the droplets of the film material 3 on the substrate 2 are spread to form a film. The droplets of the film material 3 heated to the predetermined temperature are spread to form a film by the surface tension.

The film coating device 1 and the film coating method using same decrease the surface tension of the film material 3 by heating the film material 3 to a predetermined temperature. Thus, the film can be made more evenly.

What is said above are only preferred examples of present invention, not intended to limit the present invention, any modifications, equivalent substitutions and improvements etc. made within the spirit and principle of the present invention, should be included in the protection range of the present invention.

What is claimed is:

1. A film coating device, comprising:
a holder holding a substrate to be coated a film;
an ink sprayer spraying a film material on the substrate with a preset spraying quantity and stepping rate; and
a heater heating the film material to a predetermined temperature range during the film spraying process to reduce an uneven spread of the film material due to a surface tension difference of the film material.

2. The film coating device of claim 1, wherein the heater is set inside the holder to transfer the heat to the film material by heating the substrate.

3. The film coating device of claim 1, wherein the ink sprayer comprises a receiving cavity and a plurality of nozzles spraying the film material on the substrate.

4. The film coating device of claim 3, wherein the heater is set on the receiving cavity to directly heat the film material.

5. The film coating device of claim 3, wherein the receiving cavity is extended along a first direction and moved along a second direction perpendicular to the first direction, and the nozzles are arranged along an extending direction of the receiving cavity and spaced with a predetermined interval.

6. The film coating device of claim 4, wherein the receiving cavity is extended along a first direction, the ink sprayer is held still, and the holder is moved along the second direction.

7. The film coating device of claim 1, wherein the film material is an alignment film of liquid crystal molecules.

8. A film coating method, comprising steps of:
providing a substrate;
dropping a plurality of film material droplets on the substrate;
heating the film material droplets on the substrate to a predetermined temperature; and
spreading the film material droplets to form a film on the substrate.

9. The film coating method of claim 8, wherein washing the substrate to decrease impurity particles on a surface of the substrate before dropping the film material droplets on the substrate.

10. The film coating method of claim 8, wherein the predetermined temperature is set in a range of greater or equal to 10 Celsius degree and less than or equal to 60 Celsius degree.

11. The film coating method of claim 9, wherein the film material is an alignment film of liquid crystal molecules.
